(19) United States
(12) Patent Application Publication
(10) Pub. No.: US 2020/0349363 A1
(43) Pub. Date: Nov. 5, 2020

(54) METHOD AND SYSTEM FOR ESTIMATING LANE LINES IN VEHICLE ADVANCED DRIVER ASSISTANCE DRIVER ASSISTANCE SYSTEMS

(71) Applicants: Miguel Hurtado, Sterling Heights, MI (US); Stephen Horton, Rochester, MI (US); Eliseo Miranda, Detroit, MI (US)

(72) Inventors: Miguel Hurtado, Sterling Heights, MI (US); Stephen Horton, Rochester, MI (US); Eliseo Miranda, Detroit, MI (US)

(21) Appl. No.: 16/401,794

(22) Filed: May 2, 2019

(51) Int. Cl. G06K 9/00; G06T 7/70; B60R 1/00; G08G 1/16

(52) U.S. Cl. CPC G06K 9/00798; G06T 7/70; B60R 1/00; B60R 2300/105; G06T 2207/30256; B60R 2300/804; G08G 1/167

(57) ABSTRACT

An advanced driver assistance system (ADAS) of a vehicle and associated method is disclosed. A first set of sensed lane measurements from a first imaging device and a second set of sensed lane measurements from a second imaging device are obtained. Each of the first and second sets of sensed lane measurements includes a lane estimate for the lane lines on a roadway. Each lane estimate is associated with one lane line. For each lane line, the associated lane estimates from the first and second sets of sensed lane measurements are fused to obtain a fused lane estimate, from which a representative model lane estimate is determined. For each of the plurality of lane lines, the associated lane estimates from the first and second sets of sensed lane measurements and the representative model lane estimate are fused to obtain a corrected fused lane estimate, which is output.

### FIELD

The present application generally relates to vehicle advanced driver assistance systems (ADAS), autonomous vehicles, and, more particularly, to techniques for improving the accuracy and precision of road lane sensing in vehicle ADAS.

### BACKGROUND

Some vehicle advanced driver assistance systems (ADAS) utilize a lane detection system, either alone or in combination with other systems, to provide driver assistance. A typical lane detection system includes one or more imaging devices (such as cameras or other image sensors) that are utilized to capture an image of a roadway in the direction of travel of the vehicle. The image of the roadway is analyzed to detect lane lines. The detected lane lines are utilized to generate estimates of the lanes of travel for the vehicle. As the lane lines extend farther from the vehicle, however, it becomes more difficult to accurately detect lane lines, which can result in inaccurate lane estimates. This inaccuracy may also increase as the distance from the lane to the imaging device(s) increases. Accordingly, although the existing process for detecting lane lines may permit current vehicle advanced driver assistance systems to work well for their intended purpose, there remains a need for improvement in the relevant art.

### SUMMARY

According to one example aspect of the invention, a computer-implemented method for estimating lane lines in an advanced driver assistance system (ADAS) of a vehicle is disclosed. In one example implementation, the method includes obtaining, at a computing device having one or more processors, a first set of sensed lane measurements from a first imaging device and a second set of sensed lane measurements from a second imaging device. Each of the first and second sets of sensed lane measurements can include a lane estimate for each of a plurality of lane lines on a roadway. The method also includes associating, at the computing device, each lane estimate with one of the plurality of lane lines. For each of the plurality of lane lines, the method includes fusing the associated lane estimates from the first and second sets of sensed lane measurements to obtain a fused lane estimate. A representative model lane estimate is determined from the fused lane estimate. Further, for each of the plurality of lane lines, the method includes fusing the associated lane estimates from the first and second sets of sensed lane measurements and the representative model lane estimate to obtain a corrected fused lane estimate. The method additionally includes outputting the corrected fused lane estimate from the computing device.

In some implementations, determining the representative model lane estimate from the fused lane estimates comprises selecting a specific fused lane estimate as the representative model lane estimate. The specific fused lane estimate can, e.g., be selected based on proximity to the first or second imaging devices.

In some aspects, determining the representative model lane estimate from the fused lane estimates comprises combining at least two of the fused lane estimates to obtain the representative model lane estimate. In additional or alternative implementations, fusing the associated lane estimates from the first and second sets of sensed lane measurements to obtain the fused lane estimate comprises utilizing a Kalman filter.

According to some aspects, fusing the associated lane estimates from the first and second sets of sensed lane measurements and the representative model lane estimate to obtain the corrected fused lane estimate comprises utilizing one or more characteristics of the selected representative model lane estimate to generate a simulated model lane estimate, and fusing the associated lane estimates from the first and second sets of sensed lane measurements and the simulated model lane estimate to obtain the corrected fused lane estimate. The one or more characteristics of the selected representative model lane estimate can be selected from a slope, a curvature, and a rate of curvature, although other characteristics are within the scope of the present disclosure.

Outputting the corrected fused lane estimate, in some implementations, comprises providing the corrected fused lane estimate to a guidance system of the ADAS of the vehicle, and guiding the vehicle based at least in part on the corrected fused lane estimate.

In some examples, each of the first and second imaging devices comprises an optical camera, an infrared sensor, or a light detection and ranging (LIDAR) system.

According to another example aspect of the invention, an advanced driver assistance system (ADAS) for a vehicle is disclosed. The ADAS includes a first imaging device, a second imaging device, and a computing device. The computing device comprises one or more processors and a non-transitory computer-readable storage medium having a plurality of instructions stored thereon. The plurality of instructions, when executed by the one or more processors, cause the one or more processors to perform operations for estimating lane lines on a roadway. The operations include obtaining a first set of sensed lane measurements from the first imaging device and a second set of sensed lane measurements from the second imaging device. Each of the first and second sets of sensed lane measurements can include a lane estimate for each of a plurality of lane lines on the roadway. The operations also include associating each lane estimate with one of the plurality of lane lines. For each of the plurality of lane lines, the operations include fusing the associated lane estimates from the first and second sets of sensed lane measurements to obtain a fused lane estimate. A representative model lane estimate is determined from the fused lane estimate. Further, for each of the plurality of lane lines, the operations include fusing the associated lane estimates from the first and second sets of sensed lane measurements and the representative model lane estimate to obtain a corrected fused lane estimate. The operations additionally include outputting the corrected fused lane estimate from the computing device.

In some implementations, determining the representative model lane estimate from the fused lane estimates comprises selecting a specific fused lane estimate as the representative model lane estimate. The specific fused lane estimate can, e.g., be selected based on proximity to the first or second imaging devices.

In some aspects, determining the representative model lane estimate from the fused lane estimates comprises combining at least two of the fused lane estimates to obtain the representative model lane estimate. In additional or alternative implementations, fusing the associated lane estimates from the first and second sets of sensed lane measurements to obtain the fused lane estimate comprises utilizing a Kalman filter.

According to some aspects, fusing the associated lane estimates from the first and second sets of sensed lane measurements and the representative model lane estimate to obtain the corrected fused lane estimate comprises utilizing one or more characteristics of the selected representative model lane estimate to generate a simulated model lane estimate, and fusing the associated lane estimates from the first and second sets of sensed lane measurements and the simulated model lane estimate to obtain the corrected fused lane estimate. The one or more characteristics of the selected representative model lane estimate can be selected from a slope, a curvature, and a rate of curvature, although other characteristics are within the scope of the present disclosure.

Outputting the corrected fused lane estimate, in some implementations, comprises providing the corrected fused lane estimate to a guidance system of the ADAS of the vehicle, and guiding the vehicle based at least in part on the corrected fused lane estimate.

In some examples, each of the first and second imaging devices comprises an optical camera, an infrared sensor, or a light detection and ranging (LIDAR) system.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle having an advanced driver assistance system (ADAS) that performs lane line estimation techniques according to some implementations of the present disclosure;

FIG. 2 is a functional block diagram of a lane line estimation architecture according to some implementations of the present disclosure;

FIG. 3 is a schematic illustration of an example result of a lane line estimation technique according to some implementations of the present disclosure;

FIG. 4 is a schematic illustration of another example result of a lane line estimation technique according to some implementations of the present disclosure; and

FIG. 5 is a flow diagram of an example method for estimating lane lines in an ADAS of a vehicle according to some implementations of the present disclosure.

### DETAILED DESCRIPTION

As discussed above, there exists a need for improvement in advanced driver assistance systems (ADAS) and the lane detection techniques thereof. It will be appreciated that the term “ADAS” as used herein includes driver assistance systems (lane keeping, adaptive cruise control, etc.) as well as partially and fully autonomous driving systems. The ADAS disclosed herein include a plurality of imaging devices (optical cameras, infrared sensors, light detection and ranging (LIDAR) systems, etc.) for obtaining images of a roadway. The images of the roadway are analyzed to obtain sensed lane measurements for each of the imaging devices. The sensed lane measurements will include a lane estimate for each of the lane lines of the roadway. Each of these lane estimates can be associated with a particular lane line such that each lane line will have multiple lane estimates (such as one from each of the imaging devices) associated therewith.

The images from different imaging devices will likely have different sensed lane measurements for the same lane lines, e.g., due to each imaging device having a different position on the vehicle and/or perspective of the roadway and on the intrinsic accuracy and precision of the imaging device. Due to this and other factors, the multiple lane estimates for each particular lane may differ from each other and also from the actual lane lines (or “ground truth”) of the roadway. Accordingly, the present disclosure describes techniques by which the lane estimates for each particular lane are combined or “fused” to obtain fused lane estimates in an attempt to more accurately represent the actual lane lines of the roadway.

As mentioned above, as the distance between the actual lane lines and the vehicle or imaging device(s) increases, the accuracy of the lane estimates may decrease. Thus, the estimated lane lines of lanes that are laterally distant from a vehicle may be less accurate than those of the lane lines for the lane in which the vehicle is travelling. In a situation where a relatively large error in a single lane estimate (e.g., due to a large distance between the lane line and imaging device associated with the lane estimate) is combined with other lane estimate(s) that do not include such an error, the resulting fused lane estimate can be less accurate than is desired. Furthermore, it is possible that a fused lane estimate may be less accurate than desired in other situations.

In order to address the above, the disclosed techniques propose determining a representative model lane estimate from the fused lane estimates for all lanes, and then recombining or fusing the representative model lane estimate with the lane estimates for each of the plurality of lanes. The representative model lane estimate is intended to be an accurate estimate of the lane lines of the roadway. For example only, the representative model lane estimate may be selected from the fused lane estimates based on a proximity to the imaging device(s) such that the representative model lane estimate is associated with a lane line that is proximate the imaging device(s) or one of the lane lines for the lane in which the vehicle is travelling. In this manner, a more accurate or “corrected” fused lane estimate will be obtained.

To summarize, the disclosed techniques combine or fuse a plurality of lane estimates (each lane estimate being from a different imaging device) for each lane line of a roadway to obtain a fused lane estimate for each lane line. A representative model lane estimate is determined from the fused lane estimates, where the representative model lane estimate is an accurate representation of its associated lane line. Based on the assumption that, on a roadway, the curvature for a single lane line (such as that of the representative model lane estimate) is substantially similar to the curvature of the remaining lane lines, the representative model lane estimate can be fused with the plurality of lane estimates for each of the lane lines to obtain a more accurate “corrected” fused lane estimate for each lane line.

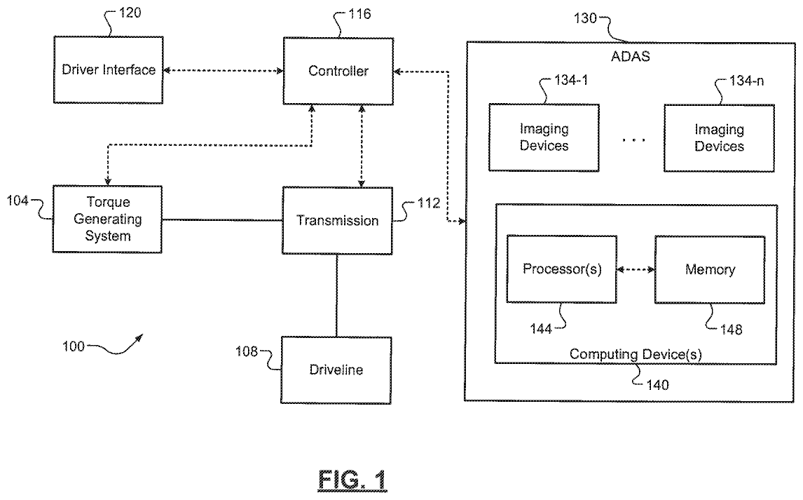

Referring now to FIG. 1, a functional block diagram of an example vehicle 100 is illustrated. The vehicle 100 comprises a torque generating system 104 (an engine, an electric motor, combinations thereof, etc.) that generates drive torque that is transferred to a driveline 108 via a transmission 112. A controller 116 controls operation of the torque generating system 104, such as to generate a desired drive torque based on a driver input via a driver interface 120 (a touch display, an accelerator pedal, combinations thereof, etc.). The vehicle 100 further comprises an ADAS 130 having a plurality of imaging devices 134-1, . . . 134-n (referred to herein individually or collectively as “imaging device 134” or “imaging devices 134”) and one or more computing devices 140 (referred to herein individually or collectively as “computing device 140”). While the ADAS 130 is illustrated as being separate from the controller 116, it will be appreciated that the ADAS 130 could be incorporated as part of the controller 116, or the ADAS 130 could have its own separate controller.

The imaging devices 134 can include optical cameras, infrared sensors, light detection and ranging (LIDAR) systems, and any other sensing device or combination thereof for obtaining images of a roadway. The computing device 140 can include one or more processors 144 and a non-transitory computer-readable storage medium, hereinafter referred to as a memory 148. The memory 148 has instructions stored thereon that, when executed by the one or more processors 144, cause the computing device 140 and/or processors 144 to perform operations, such as those of the techniques of the present disclosure described herein. It should be appreciated that the ADAS 130 could include other suitable systems, such as, but not limited to, a radio detection and ranging (RADIO) system, an inertial motion unit (IMU) system, a real-time kinematic (RTK) system, and a Differential Global Positioning System (“DGPS”).

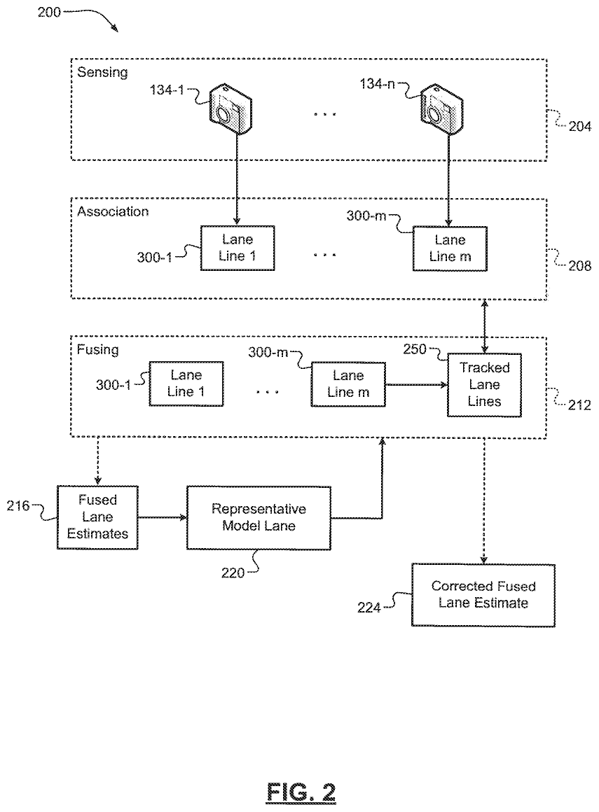

Referring now to FIG. 2, a functional block diagram of an example lane line estimation architecture 200 is illustrated. This architecture 200 is implemented primarily by the ADAS 130, but, as mentioned above, portions of the techniques described herein could be implemented by the controller 116 or other components of the vehicle 100. At 204, a sensing process is implemented in which sets of sensed lane measurements are obtained, e.g., from a plurality of imaging devices 134. As mentioned above, the sensed lane measurements will include a lane estimate for each of the lane lines 300-1, . . . 300-m (referred to herein individually or collectively as “lane line(s) 300”) of the roadway.

At 208, an association process is implemented in which the lane estimates are associated with a particular lane line 300 such that each lane line 300 will have multiple lane estimates (such as one from each of the imaging devices 134) associated therewith. In some aspects, the ADAS 130 utilizes a list or other record of tracked lane lines 250 that is used during the association process 208. At 212, a fusing process is implemented in which the lane estimates for each of lane lines 300 are fused/combined to obtain a fused lane estimate 216 for each lane line 300. The fusing process 212 is performed on a lane line-by-lane line basis. That is, each lane line 300 is examined separately and the lane estimates for each particular lane line are fused for that particular lane line. In this manner, a fused lane estimate 216 for each particular lane line 300 is obtained, where the fused lane estimate 216 results from the fusing of the lane estimates for that particular lane line 300. In some implementations, the fusing process 212 utilizes a Kalman filter to fuse the lane estimates for each of lane lines 300 in order to obtain a fused lane estimate 216 for each lane line 300. Other techniques for fusing the lane estimates are within the scope of the present disclosure.

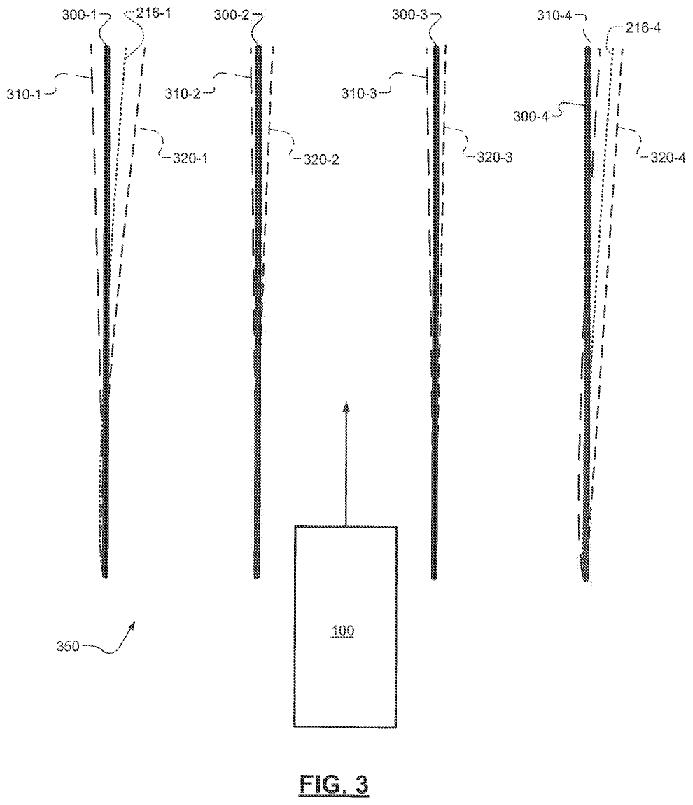

With further reference to FIG. 3, which is a schematic illustration of an example result of a lane line estimation technique, a vehicle 100 is shown as travelling on a roadway 350. The roadway 350 includes a plurality of lane lines 300-1, 300-2, 300-3, and 300-4. In the illustrated example, there are two sets of sensed lane measurements and, accordingly, two lane estimates 310, 320 for each lane line 300. For the lane line 300-1, there is a first lane estimate 310-1 and a second lane estimate 320-1. Similarly, for the lane line 300-2, there is a first lane estimate 310-2 and a second lane estimate 320-2; for the lane line 300-3, there is a first lane estimate 310-3 and a second lane estimate 320-3; and for the lane line 300-4, there is a first lane estimate 310-4 and a second lane estimate 320-4.

As shown in FIG. 3, the lane estimates 310, 320 can be somewhat inaccurate, especially for those lane lines (300-1, 300-4) that are farther from the vehicle 100. Accordingly, the fusing process 212 combines the lane estimates 310, 320 on lane line-by-lane line basis, as mentioned above, to obtain a fused lane estimate 216 for each lane line 300, for example, a fused lane estimate 216-1 for lane line 300-1 and fused lane estimate 216-4 for lane line 300-4. The fused lane estimates 216 for lane lines 300-2 and 300-3 are not illustrated as they cannot be visually distinguished from the lane lines 300-2, 300-3 in FIG. 3.

Referring back to FIG. 2, a representative model lane estimate 220 from the fused lane estimates 216 is determined. As mentioned above, the representative model lane estimate 220 is intended to be an accurate estimate of the lane lines 300 of the roadway. For example only, the representative model lane estimate 220 may be selected from the fused lane estimates 216 based on a proximity to the imaging device(s) 134 or vehicle 100 such that the representative model lane estimate 220 is associated with a lane line 300 that is proximate the imaging device(s) 134 or with one of the lane lines 300 for the lane in which the vehicle 100 is travelling.

The determination of the representative model lane estimate 220 from the fused lane estimates 216 can be accomplished in various ways. For example only, the representative model lane estimate 220 can be determined from the fused lane estimates 216 by selecting a specific fused lane estimate 216 as the representative model lane estimate 200, such as based on the proximity to the imaging devices 134 or vehicle 100. Alternatively, the representative model lane estimate 220 can be determined from the fused lane estimates 216 by averaging or otherwise combining at least two of the fused lane estimates 216 to obtain the representative model lane estimate 220. Other techniques for determining the representative model lane estimate 220 are within the scope of this disclosure.

In some implementations, the representative model lane estimate 220 is utilized as an input to the fusing process 212 in which the lane estimates 310, 320 for each of lane lines 300 and the representative lane estimate 220 are fused/combined to obtain a corrected fused lane estimate 224 for each lane line 300. As described above, the fusing process 212 is performed on a lane line-by-lane line basis such that each lane line 300 is examined separately. In this manner, a more accurate or corrected fused lane estimate 224 will be obtained. As mentioned above, in some implementations the fusing process 212 utilizes a Kalman filter to fuse the lane estimates 310, 320 and the representative lane estimate 220 in order to obtain a corrected fused lane estimate 216 for each lane line 300. Other techniques for fusing the lane estimates 310, 320 and the representative lane estimate 220 are within the scope of the present disclosure.

It should be appreciated that the fusing of the representative model lane estimate 220 and the lane estimates 310, 320, does not necessarily include combining each and every characteristic of the representative model lane estimate 220. Each lane estimate 310 and the representative model lane estimate 220 can be defined by various characteristics, including but not limited to an offset (distance/direction from a reference point, such as an imaging device 134), a slope or tangent (first derivative), a curvature (second derivative), and a rate of curvature (third derivative). In some aspects, the fusing of the representative model lane estimate 220 and the lane estimates 310, 320 comprises utilizing one or more of the characteristics of the representative model lane estimate 220 to generate a simulated model lane estimate and fusing the simulated model lane estimate and the lane estimates 310, 320 to obtain the corrected fused lane estimate 224. For example only, the offset of the representative model lane estimate 220 can be ignored as this characteristic is specific to the lane line 300 under analysis and should not be extrapolated to other lane lines 300. One or more of the slope, curvature, rate of curvature, etc., however, can be applicable to the lane lines 300 more generally and can be fused with the lane estimates 310, 320.

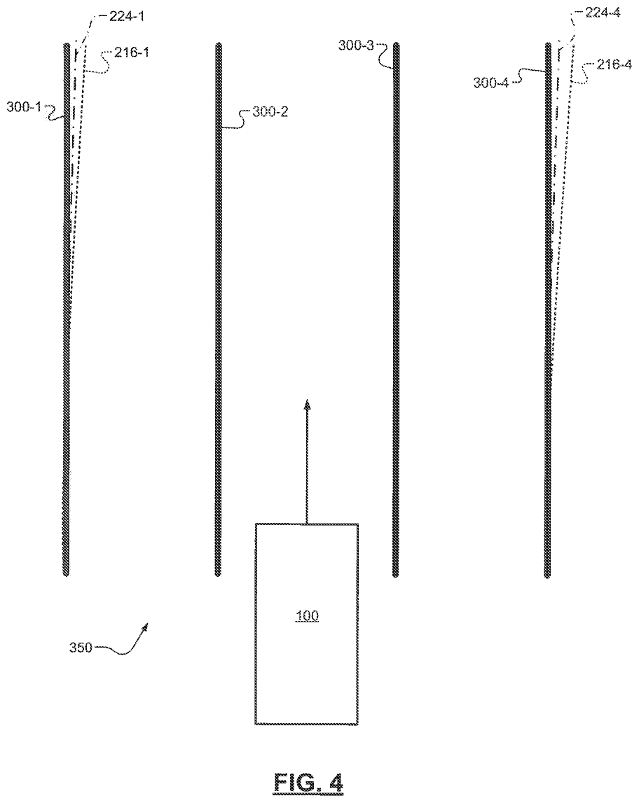

With further reference to FIG. 4, which is a schematic illustration of an example result of a lane line estimation technique, a vehicle 100 is shown as travelling on a roadway 350. FIG. 4 is similar to FIG. 3 but, for ease of illustration, does not include the two lane estimates 310, 320 for each lane line 300. FIG. 4 shows the results of the fusing of the representative model lane estimate 220 and the lane estimates 310, 320, which are illustrated as the corrected fused lane estimates 224 (a corrected fused lane estimate 224-1 for lane line 300-1 and corrected fused lane estimate 224-4 for lane line 300-4). The corrected fused lane estimates 224 for lane lines 300-2 and 300-3 are not illustrated as they cannot be visually distinguished from the lane lines 300-2, 300-3 in FIG. 4. As shown in FIG. 4, the corrected fused lane estimates 224 can be more accurate than the fused lane estimates 216, especially for those lane lines (300-1, 300-4) that are farther from the vehicle 100.

The corrected fused lane estimates 224 can be output by the ADAS 130 in various manners. For example only, the outputting can include providing the corrected fused lane estimate 224 to a guidance system of the ADAS 130 of the vehicle 100 (and/or the controller 116 or other components of the vehicle 100) in order to guide the vehicle 100 based at least in part on the corrected fused lane estimate 224. The outputting can further include utilizing the corrected fused lane estimate 224 to provide lateral control, lane biasing, localization, and other guidance/positioning control of the vehicle 100.

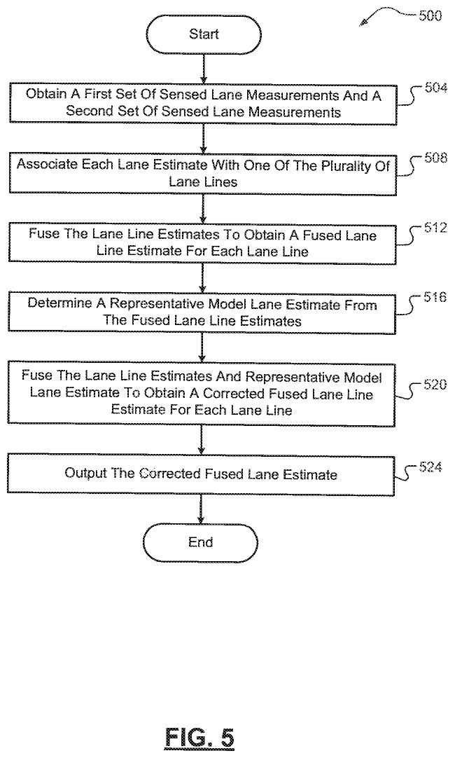

With specific reference to FIG. 5, a flow diagram of a method 500 for estimating lane lines in an ADAS 130 of a vehicle 100 is illustrated. The method 500 can be performed by any computing device, including but not limited to the ADAS 130, the controller 116, the computing device(s) 140, and/or another computing device of the vehicle 100. For ease of description, the method 500 will be described hereinafter as being performed by the ADAS 130.

At 504, the ADAS 130 obtains a first set of sensed lane measurements from a first imaging device 134 and a second set of sensed lane measurements from a second imaging device 134. The first set of sensed lane measurements includes a first lane estimate 310 for each of a plurality of lane lines 300 on a roadway 350. Similarly, the second set of sensed lane measurements includes a second lane estimate 320 for each of a plurality of lane lines 300 on the roadway 350.

At 508, each lane estimate 310, 320 is associated with one of the plurality of lane lines 300. As mentioned above, the ADAS 130 may utilize a list or other record of tracked lane lines 250 to assist with the association 508. At 512, the lane estimates 310 for each of lane lines 300 are fused/combined to obtain a fused lane estimate 216 for each lane line 300. As mentioned above, fusing 512 is performed on a lane line-by-lane line basis such that each lane line 300 is examined separately and the lane estimates 310, 320 for each particular lane line 300 are fused for that particular lane line 300.

At 516, a representative model lane estimate 220 from the fused lane estimates 216 is determined. As described above, the representative model lane estimate 220 is intended to be an accurate estimate of the lane lines 300 of the roadway 350. At 520, the lane estimates 310, 320 for each of lane lines 300 and the representative lane estimate 220 are fused/combined to obtain a corrected fused lane estimate 224 for each lane line 300. In this manner, a more accurate or corrected fused lane estimate 224 will be obtained. Finally, at 524 the corrected fused lane estimate 224 is output, e.g., by providing the corrected fused lane estimate 224 to a guidance system of the ADAS 130 of the vehicle 100 (and/or the controller 116 or other components of the vehicle 100) in order to guide the vehicle 100 based at least in part on the corrected fused lane estimate 224.

The lane line estimation techniques described above provide an improved and more accurate estimation of lane lines 300 than traditional lane detection systems. Further, the disclosed lane line estimation techniques can be utilized without additional hardware components, resulting in improved performance without increased complexity of components.

It should be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The controller could also include a memory as described above for storing sensor data and the like. The one or more processors could be either a single processor or two or more processors operating in a parallel or distributed architecture. The term “computing device” as used (or computing devices) refers to any suitable computing device or group of multiple computing devices that include(s) one or more processors and a non-transitory storage medium or memory having instructions stored thereon and is/are configured to perform at least a portion of the techniques of the present disclosure.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A method for estimating lane lines in an advanced driver assistance system (ADAS) of a vehicle, comprising:
obtaining, at a computing device having one or more processors, a first set of sensed lane measurements from a first imaging device and a second set of sensed lane measurements from a second imaging device, each of the first and second sets of sensed lane measurements including a lane estimate for each of a plurality of lane lines on a roadway;
associating, at the computing device, each lane estimate with one of the plurality of lane lines;
for each of the plurality of lane lines: fusing, at the computing device, the associated lane estimates from the first and second sets of sensed lane measurements to obtain a fused lane estimate;
determining, at the computing device, a representative model lane estimate from the fused lane estimates;
for each of the plurality of lane lines: fusing, at the computing device, the associated lane estimates from the first and second sets of sensed lane measurements and the representative model lane estimate to obtain a corrected fused lane estimate; and
outputting, from the computing device, the corrected fused lane estimate.

2. The method of claim 1, wherein determining the representative model lane estimate from the fused lane estimates comprises selecting a specific fused lane estimate as the representative model lane estimate.

3. The method of claim 2, wherein the specific fused lane estimate is selected based on proximity to the first or second imaging devices.

4. The method of claim 1, wherein determining the representative model lane estimate from the fused lane estimates comprises combining at least two of the fused lane estimates to obtain the representative model lane estimate.

5. The method of claim 1, wherein fusing the associated lane estimates from the first and second sets of sensed lane measurements to obtain the fused lane estimate comprises utilizing a Kalman filter.

6. The method of claim 1, wherein fusing the associated lane estimates from the first and second sets of sensed lane measurements and the representative model lane estimate to obtain the corrected fused lane estimate comprises:
utilizing one or more characteristics of the selected representative model lane estimate to generate a simulated model lane estimate; and
fusing the associated lane estimates from the first and second sets of sensed lane measurements and the simulated model lane estimate to obtain the corrected fused lane estimate.

7. The method of claim 6, wherein the one or more characteristics of the selected representative model lane estimate are selected from a slope, a curvature, and a rate of curvature.

8. The method of claim 1, wherein outputting the corrected fused lane estimate comprises:
providing the corrected fused lane estimate to a guidance system of the ADAS of the vehicle; and
guiding the vehicle based at least in part on the corrected fused lane estimate.

9. The method of claim 1, wherein each of the first and second imaging devices comprises an optical camera, an infrared sensor, or a light detection and ranging (LIDAR) system.

10. An advanced driver assistance system (ADAS) for a vehicle, comprising:
a first imaging device;
a second imaging device; and
a computing device comprising:
one or more processors; and
a non-transitory computer-readable storage medium having a plurality of instructions stored thereon, which, when executed by the one or more processors, cause the one or more processors to perform operations comprising:
obtaining a first set of sensed lane measurements from the first imaging device and a second set of sensed lane measurements from the second imaging device, each of the first and second sets of sensed lane measurements including a lane estimate for each of a plurality of lane lines on a roadway;
associating each lane estimate with one of the plurality of lane lines;
for each of the plurality of lane lines: fusing the associated lane estimates from the first and second sets of sensed lane measurements to obtain a fused lane estimate;
determining a representative model lane estimate from the fused lane estimates;
for each of the plurality of lane lines: fusing the associated lane estimates from the first and second sets of sensed lane measurements and the representative model lane estimate to obtain a corrected fused lane estimate; and
outputting the corrected fused lane estimate.

11. The advanced driver assistance system of claim 10, wherein determining the representative model lane estimate from the fused lane estimates comprises selecting a specific fused lane estimate as the representative model lane estimate.

12. The advanced driver assistance system of claim 11, wherein the specific fused lane estimate is selected based on proximity to the first or second imaging devices.

13. The advanced driver assistance system of claim 10, wherein determining the representative model lane estimate from the fused lane estimates comprises combining at least two of the fused lane estimates to obtain the representative model lane estimate.

14. The advanced driver assistance system of claim 10, wherein fusing the associated lane estimates from the first and second sets of sensed lane measurements to obtain the fused lane estimate comprises utilizing a Kalman filter.

15. The advanced driver assistance system of claim 10, wherein fusing the associated lane estimates from the first and second sets of sensed lane measurements and the representative model lane estimate to obtain the corrected fused lane estimate comprises:
utilizing one or more characteristics of the selected representative model lane estimate to generate a simulated model lane estimate; and
fusing the associated lane estimates from the first and second sets of sensed lane measurements and the simulated model lane estimate to obtain the corrected fused lane estimate.

16. The advanced driver assistance system of claim 15, wherein the one or more characteristics of the selected representative model lane estimate are selected from a slope, a curvature, and a rate of curvature.

17. The advanced driver assistance system of claim 10, further comprising a guidance system for the vehicle, wherein outputting the corrected fused lane estimate comprises:
providing the corrected fused lane estimate to the guidance system for the vehicle; and
guiding the vehicle based at least in part on the corrected fused lane estimate.

18. The advanced driver assistance system of claim 10, wherein each of the first and second imaging devices comprises an optical camera, an infrared sensor, or a light detection and ranging (LIDAR) system.
